(19) United States
(12) Patent Application Publication
(10) Pub. No.: US 2023/0327465 A1
(43) Pub. Date: Oct. 12, 2023

(54) Standalone Lithium-Ion Rechargeable DC Power Pack Supply device with LED Voltage/Power Real Time Monitoring, with Safety Protection, Power Bank-Backup, and Charging Circuit

(71) Applicant: Nermin Osmanovic, Austin, TX (US)

(72) Inventor: Nermin Osmanovic, Austin, TX (US)

(21) Appl. No.: 18/142,468

(22) Filed: May 2, 2023

(51) Int. Cl. H02J 7/00; H01M 10/658; H01M 10/0525

(52) U.S. Cl. CPC H02J 7/0045; H02J 7/00309; H01M 10/658; H01M 10/0525; H02J 7/0048

(57) ABSTRACT

This utility patent application describes a novel hardware design for a portable DC power supply system. The system includes a lithium-ion battery cell, DC/DC boost converter circuit, LED DC voltage/energy monitoring circuit, charging circuit, and various hardware switches and connectors. The system may include a secondary battery cell for additional backup in case the primary cell runs out of energy or becomes damaged. Each battery cell is protected with advanced safety protection circuitry and a manual disconnect switch to prevent thermal runaway events. The system features automatic charging and can be recharged from multiple sources, enabling off-grid charging. The LED voltage/power metering allows easy status monitoring, and the system is designed for long reliability performance and top-class lithium-ion battery safety. The system is operated manually with hardware switches to minimize software failure points. Overall, this novel hardware design provides a reliable and efficient solution for portable DC power needs.

### BACKGROUND OF THE INVENTION

At least one specification heading is required. Please delete this heading section if it is not applicable to your application. For more information regarding the headings of the specification, please see MPEP 608.01(a).

Portable electronic devices such as smartphones, tablets, and other similar devices have become an integral part of our daily lives. However, one common issue faced by users of these devices is the limited battery life, which often requires frequent recharging.

This can be particularly inconvenient when users are on the go or do not have access to a power source. Existing solutions to extend battery life include power banks or external battery packs that are separate devices that users need to carry around separately. These can be bulky, inconvenient to use, and may require additional cables or connectors.

There is a need for a more seamless and integrated solution that can provide extended battery life to existing devices without adding unnecessary bulk or complexity. The present invention relates to a new device called the “DC Power Pack” which contains a protected lithium-ion (Li-ion) cell battery that attaches to the bottom of existing devices, such as a Guitar Pedal or a MacBook Pro.

The DC Power Pack includes LEDs for visual monitoring of available power in the cell, serving as an “energy power meter.” The device is designed to provide enhanced safety with protection against thermal runaway, significantly reducing the chances of such incidents occurring.

### DESCRIPTION

The DC Power Pack is a seamless extension device that attaches to the bottom of existing devices, such as a Guitar Pedal or a MacBook Pro, to provide a reliable and convenient source of power. It includes a protected Li-ion cell battery that is designed to provide optimal power output and efficiency, ensuring the smooth operation of the attached device.

The DC Power Pack is equipped with LEDs that serve as an “energy power meter,” providing visual monitoring of the available power in the cell. Users can easily monitor the power level of the DC Power Pack through these LEDs, allowing them to know when it's time to recharge the battery.

This feature provides enhanced convenience and usability, ensuring that users can always keep their devices powered up. One of the key innovations of the DC Power Pack is its advanced safety features. The device is designed to significantly reduce the chances of thermal runaway, a dangerous phenomenon that can occur in Li-ion batteries.

The DC Power Pack incorporates advanced protection mechanisms, including thermal sensors, voltage and current protection, and overcharge/overdischarge protection, to ensure the highest level of safety during operation. The DC Power Pack is designed to be easy to use. Customers simply mount the device to the bottom of their existing device, connect the power connector, and turn on the power.

They can then watch and monitor the LED voltage power meters to keep track of the available power. When the battery needs recharging, users can easily recharge the DC Power Pack as needed, ensuring that they always have a reliable source of power for their device.

### SUMMARY OF THE INVENTION

The present invention relates to a standalone Lithium-Ion rechargeable DC-power supply device with LED voltage/power real-time monitoring, safety protection, PowerBank-backup, and charging circuit.

The device includes a novel system hardware design comprising of hardware switches, connectors, DC/DC boost converter circuit, LED DC voltage/energy monitoring circuit, charging circuit, and a lithium-ion battery cell.

The device may also include a secondary battery cell for additional backup, allowing for easy activation in case the first cell runs out of energy completely or gets damaged. The lithium-ion battery cell in the device is protected with an advanced safety protection circuit and manual disconnect switch, significantly reducing the chances of a thermal runaway event.

The device also includes an automatic charging circuit implemented in hardware, allowing for recharging from multiple sources, including off-grid charging. The device is capable of providing multiple preset DC voltages, such as 5, 9, 12, 18, and 24V, with the possibility of custom voltages by adjusting the potentiometer on the DC/DC boost circuit.

One of the unique features of the device is the LED voltage/power monitoring, which provides real-time status monitoring with a simple glance. When the battery is discharged, a red LED is lit, indicating the need for recharge. The device also has a quick and easy charging process with a connector insert, and the charging time depends on the circuit implementation, ranging from 2 to 6 hours.

To ensure reliability and durability, the device is designed with a system diagram consisting of hardware switches, connectors, and sub-modules connected with wires/cabling. The Lithium-Ion battery cell used in the device is of the hybrid type, capable of being recharged up to 1000 times without significant loss of capacity, and is designed for top-class safety performance.

Furthermore, the device is built to withstand tough conditions, with a splash and rain-proof enclosure for live shows and road touring in the music industry. Overall, the standalone Lithium-Ion rechargeable DC-power supply device with LED voltage/power real-time monitoring, safety protection, PowerBank-backup, and charging circuit offers an innovative and reliable solution for powering various DC devices, such as guitar pedals, audio equipment, and other portable electronic devices, in a convenient and efficient manner.

### OBJECT OF THE INVENTION

Object of the invention is to provide people with extended power supply that is battery-based, for long usage off-grid. Few advantages include:

Advanced safety protection circuit and manual disconnect switch for the lithium-ion battery cell, reducing the risk of thermal runaway events.

LED voltage/power real-time monitoring for quick and easy status monitoring with a glance.

Automatic charging circuit implemented in hardware, allowing for charging from multiple sources, including off-grid charging.

Customizable DC voltages with preset options and adjustable potentiometer for flexibility in powering various DC devices.

Additional backup battery cell for PowerBank-backup feature, providing uninterrupted power supply in case of battery depletion or damage.

Hybrid lithium-ion battery cell capable of being recharged up to 1000 times without significant loss of capacity, ensuring long-term reliability.

Splash and rain-proof enclosure for durability in live shows and road touring conditions.

### BACKGROUND ART

The attachable li-ion cell battery can provide several advantages over existing solutions, including:

Seamless Integration: The attachable battery is designed to seamlessly integrate with existing devices, without adding unnecessary bulk or complexity. It can be attached and detached easily, providing extended battery life only when needed.

Portability: The slim and lightweight design of the attachable battery makes it highly portable, allowing users to carry it with their devices without much inconvenience.

Convenience: Users do not need to carry separate power banks or external battery packs, or deal with additional cables or connectors. The attachable battery provides a more convenient and user-friendly solution for extended battery life.

Versatility: The attachable battery can be used with various devices, such as smartphones, tablets, or other portable electronic devices, making it a versatile solution for different user needs.

Compatibility: The attachable battery can be designed to be compatible with different types of devices, brands, and models, providing a wide range of applications and markets.

The present invention relates to a new device containing a protected lithium-ion (Li-ion) cell battery that is designed to attach to the bottom of existing devices, providing a convenient and efficient power source. The new device is utilized in a simple and straightforward manner, making it easy for users to connect and monitor the power status of their devices.

### BRIEF DESCRIPTION OF DRAWINGS

FIG. 1: DC Power Pack, with LED Voltage Meters, and the Guitar Pedal.

FIG. 2: Drawing of DC Power Pack, mounted to Guitar Pedal.

FIG. 3: System diagram showing the hardware switches, connectors, DC/DC boost converter circuit, LED DC voltage/energy monitoring circuit, charging circuit, and lithium-ion battery cell.

FIG. 4: System diagram showing the additional backup battery cell for Power Bank backup feature, allowing for easy switchover in case of the first cell being drained or damaged.

### DETAILED DESCRIPTION

The new device comprises a protected Li-ion cell battery that is housed in a durable and compact casing. The casing is designed to securely attach to the bottom of various types of devices. The device further includes a power connector that is electrically connected to the Li-ion cell battery, allowing for easy connection to the existing device. The operation of the new device is as follows:

1. Mount the new device to the bottom of the existing device: The user attaches the device to the bottom of their electronic device using the provided adhesive, clips, or other suitable means. The casing of the new device is designed to fit seamlessly with the existing device, providing a sleek and integrated appearance.

2. Connect the Power Connector: The user then connects the power connector of the new device to the appropriate power input of the existing device.

3. Turn On the Power: Once the power connector is securely connected, the user turns on the power of the new device using a power switch or button. The protected Li-ion cell battery of the new device then provides power to the existing device, allowing it to function normally.

4. Watch/Monitor LED Voltage Power Meters: The new device is equipped with LED voltage power meters that provide real-time monitoring of the power status. The LED meters display the remaining power level of the Li-ion cell battery, allowing the user to easily monitor the power status of both the new device and the existing device. This helps users to manage their power usage and know when to recharge the new device.

5. Recharge When Needed: When the power level of the new device is low, the user can recharge it using a suitable charging method, such as connecting it to a power source using a charging cable. The protected Li-ion cell battery of the new device is designed to have a long-lasting and reliable performance, providing a durable power source for the existing device.

### DESCRIPTION OF THE INVENTION

The DC Power Pack is a new and innovative device that provides a reliable and convenient source of power for existing devices, such as Guitar Pedals and MacBook Pros. Its advanced safety features, including protection against thermal runaway, make it a safer option for powering devices. The LED voltage power meters provide visual monitoring of the available power, ensuring that users can always keep track of their power level. The DC Power Pack is designed to be a seamless extension of the customer's device, providing enhanced convenience and usability.

### DETAILED DESCRIPTION OF THE INVENTION

A novel system hardware design comprising of hardware switches, connectors, DC/DC boost converter circuit, LED DC voltage/energy monitoring circuit, charging circuit, and a lithium-ion battery cell.

A variation of this device design may include secondary battery cell for additional backup, if the first cell runs out of energy completely, or gets damaged, it is easy to activate the secondary backup cell with a flip of a switch.

Each battery cell is protected with advanced safety protection circuit, and manual disconnect switch, therefore reducing any chance of thermal runaway event practically to null. The devices include automatic charging circuit implemented in hardware.

The device may be recharged from multiple sources, enabling charging off-grid. Device can be set to several pre-set DC voltages for common scenarios: 5, 9, 12, 18, and 24V. Additional custom voltages are possible by adjusting the potentiometer on the DC/DC Boost circuit. For 100 mA current draw (typical guitar pedal), the DC Power Pack Supply can provide 35 hours of continuous operation.

Once the battery is discharged, only the RED LED will be lit, notifying customer that it is time to recharge. The LED Voltage/Power metering enables quick and easy status monitoring with a glance of an eye. With a simple connector insert, customer can begin the charging process.

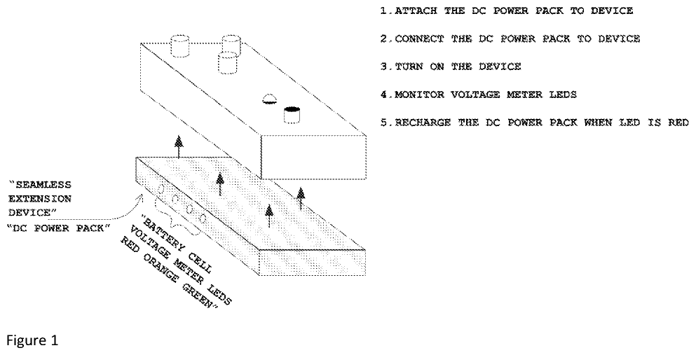

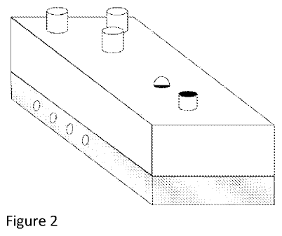

Dependent on circuit implementation, charging can take anywhere from 2 to 6 hours. The system diagram is shown in FIG. 1, consisting of hardware switches, connectors, DC/DC boost converter circuit, LED DC voltage/energy monitoring circuit, charging circuit, and a lithium-ion battery cell. For additional backup, an additional cell may be included in the system to enable the PowerBank-Backup feature. This is shown in FIG. 2.

The PowerBank Backup feature enables easy instantaneous switchover in the case that the first Cell is drained, or damaged. All components act as sub-modules, and are connected with wires/cabling to make the whole system. The system operation is completely manual and implemented with hardware switches to minimize software failure points, and interruptions.

The Lithium Ion battery cell is of ‘hybrid’ type, and can be recharged 1000 times, without significant loss of battery cell capacity. The system is designed for long reliability performance, and top class Lithium Ion battery safety. System can be charged from several different sources. The casing of the system is implemented to be splash and rain proof for live shows. Enclosure is built tough for music road-touring conditions.

### DETAILED DESCRIPTION OF THE DRAWINGS

FIG. 1 shows the DC Power Pack seamless extension device at the bottom of the drawing. The DC power pack is attached to the bottom of the Guitar Pedal shown with upright arrows. The operation steps are listed on the right side of the figure.

FIG. 2 shows assembled configuration, including DC Power Pack, and the Guitar Pedal.

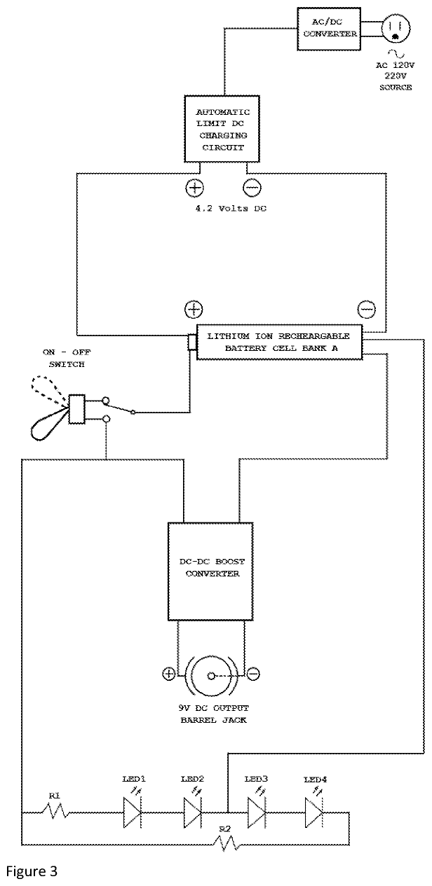

FIG. 3 shows a diagram of the single Bank battery cell system. The Battery Cell is charged to 4.2 V by the Automatic Limit DC Charging Circuit. The Main Power Switch controls ON/OFF operation. When switch is ON, the LED lights show how much energy is left in the Cell. If all 4 LEDs are lit, the Cell is full, and full capacity is available. If only one LED is lit, the Cell is empty, and must be recharged. The ON/OFF switch also engages the DC-DC Boost Converter, to convert low DC voltage to 9 Volts, and provide Power Supply to DC Output Barrel Jack.

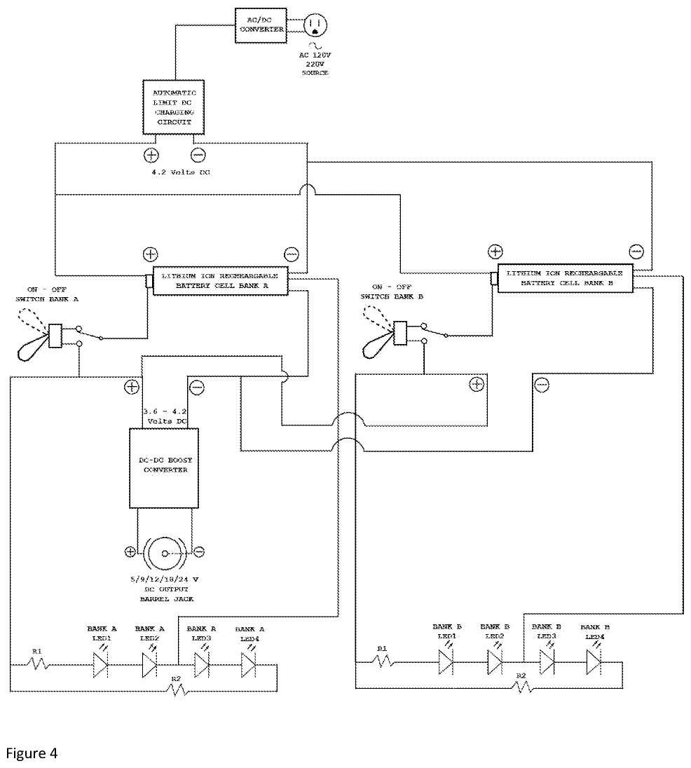

FIG. 4 shows a diagram of the Dual Bank battery cell system. Each Battery Cell is charged to 4.2 V by the Automatic Limit DC Charging Circuit. The Switch Bank A Power Switch controls ON/OFF operation of the Bank A. When Bank A switch is ON, the LED lights show how much energy is left in the Cell A. If all 4 LEDs are lit, the Cell A is full, and full capacity is available. If only one LED is lit, the Cell A is empty, and must be recharged. The ON/OFF switch Bank A also engages the DC-DC Boost Converter, to convert low DC voltage to 9 Volts, and provide Power Supply to DC Output Barrel Jack. When Bank A Cell is Discharged, or Damaged, customer can easily switch over to Bank B, by utilizing the Switch Bank B. The operation of Bank B circuit is exactly the same as Bank A. This design ensures continuous Power Supply even if Cell A is completely discharged, or damaged.

1. A standalone Lithium-Ion Rechargeable DC-Power Supply device with LED Voltage/Power Real Time Monitoring, with Safety Protection, Power Bank-Backup, and Charging Circuit, comprising:
a. a primary battery cell and a secondary battery cell for backup, wherein the secondary battery cell can be activated with a flip of a switch in case the primary battery cell runs out of energy completely or gets damaged;
b. a safety protection circuit for each battery cell, reducing the chance of thermal runaway event practically to null;
c. the ability to set the device to several pre-set DC voltages, including 5V, 9V, 12V, 18V, and 24V, and additional custom voltages possible by adjusting the potentiometer on the DC/DC Boost circuit;
d. the capability to provide 35 hours of continuous operation at 100 mA current draw;
e. a RED LED indicating the need for recharge once the battery is discharged;
f. LED Voltage/Power metering for quick and easy status monitoring;
g. an additional backup battery cell that can be included in the system to enable the PowerBank-Backup feature for easy instantaneous switchover in case of battery drain or damage;
h. all components acting as sub-modules connected with wires/cabling to form the whole system;
i. a completely manual system operation implemented with hardware switches to minimize software failure points and interruptions.

2. The ornamental design for a DC Power Pack, as shown and described, comprising a housing with a protected lithium-ion (Li-ion) cell battery that attaches to the bottom of an existing device, and includes LED voltage power meters for visual monitoring of available power in the cell.

3. The DC Power Pack of claim 1, wherein the protected Li-ion cell battery includes multiple layers of protection, reducing the chance of thermal runaway to almost zero, providing enhanced safety for the device.
